(19) United States
(12) Patent Application Publication
(10) Pub. No.: US 2014/0152030 A1
(43) Pub. Date: Jun. 5, 2014

(54) DISPOSABLE PET WASTE COLLECTOR

(71) Applicant: Josephus Johannes Maria Van Halder, Puyallup, WA (US)

(72) Inventor: Josephus Johannes Maria Van Halder, Puyallup, WA (US)

(21) Appl. No.: 13/690,971

(22) Filed: Nov. 30, 2012

(51) Int. Cl. A01K 29/00

(52) U.S. Cl. CPC A01K 29/00
USPC 294/1.3

(57) ABSTRACT

A method of collecting pet waste using a disposable pet waste collector including opening a flap coupled to a frame from a folded position of the frame to an operative position thereof to expose a collection opening in the frame; opening a bag attached to the frame so that the bag forms a receptacle protruding outwards from the collection opening; positioning the flexible frame on a surface so that the collection opening is disposed over the pet waste; and waggling the frame to collect the pet waste.

### TECHNICAL FIELD

The present invention relates to a disposable pet waste collector and method therefor, and, in particular to a disposable pet waste collector that allows picking up pet waste by covering and collecting it with a simple waggling motion.

### BACKGROUND

In many areas it is unlawful to leave pet waste on the ground and it must be picked up and disposed of properly. Pet waste, can have adverse effects on health and the environment. Pet waste can carry bacteria, viruses and other microbes. If not removed from the ground it can be washed into storm drain systems and pollute local water sources by being carried into streams and rivers without being treated.

As noted above, dog excrement also presents a significant health hazard. It can contain bacteria and viruses hazardous to humans and other animals.

Unfortunately, presently available solutions are either cumbersome to use and/or carry or are not sanitary. For example, pet owners typically use a plastic bag inverted over their hand to grasp pet waste from the ground. Besides the obvious aversion people have to handling excrement, there is always the possibility that the plastic can rupture or already has a hole that will cause unwanted contact (i.e. bacterial pass-through) with the person's hand.

In contrast to available methods and devices, the present invention provides a solution that facilitates pet waste disposal without the need for using a hand to grasp the waste directly. Use of the method of the invention provides a safe and effective way for picking up pet waste.

### SUMMARY OF THE DISCLOSURE

A method of collecting pet waste using a disposable pet waste collector is disclosed including opening a flap coupled to a frame from a folded position of the frame to an operative position thereof to expose a collection opening in the frame; opening a bag attached to the frame so that the bag forms a receptacle protruding outwards from the collection opening; positioning the frame on a surface so that the collection opening is disposed over the pet waste; and waggling the flexible frame to collect the pet waste.

In one aspect, folding the flap results in it acting as a handle support and extension, which can also served as a scoop when torn from a perforated line along the hinge.

In another aspect, the frame is flexible allowing pet waste to be picked up using a waggling motion unique to this device.

### BRIEF DESCRIPTION OF THE DRAWINGS

While the novel features of the invention are set forth with particularity in the appended claims, the invention, both as to organization and content, will be better understood and appreciated, along with other objects and features thereof, from the following detailed description taken in conjunction with the drawings, in which:

FIG. 1 schematically shows a top view of one example of a disposable pet waste collector.

FIG. 1A schematically shows an expanded view of a perforated hinge attaching a flap to a frame of a disposable pet waste collector.

FIG. 2 schematically shows a view of the back side of a disposable pet waste collector with an opened bag.

FIG. 3 schematically shows a cut-away side view of a disposable pet waste collector illustrating attachment of a bag to the frame.

FIG. 4 schematically shows a top view of a disposable pet waste collector with a flap opened to form an extended handle.

FIG. 5 schematically shows a disposable pet waste collector in an operable position.

FIG. 6 schematically shows a side view of a disposable pet waste collector.

In the drawings, identical reference numbers identify similar elements or components. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

### DETAILED DESCRIPTION OF THE PREFERRED EMBODIMENTS

The following disclosure describes several example embodiments and methods for pet waste collection. Several features of methods and systems in accordance with example embodiments are set forth and described in the Figures. It will be appreciated that methods and systems in accordance with other example embodiments can include additional procedures or features different than those shown in the Figures. Example embodiments are described herein with respect to a disposable pet waste collector. However, it will be understood that these examples are for the purpose of illustrating the principles, and that the invention is not so limited. Additionally, methods and systems in accordance with several example embodiments may not include all of the features shown in the Figures.

Unless the context requires otherwise, throughout the specification and claims which follow, the word “comprise” and variations thereof, such as, “comprises” and “comprising” are to be construed in an open, inclusive sense that is as “including, but not limited to.”

Reference throughout this specification to “one example” or “an example embodiment,” “one embodiment,” “an embodiment” or various combinations of these terms means that a particular feature, structure or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

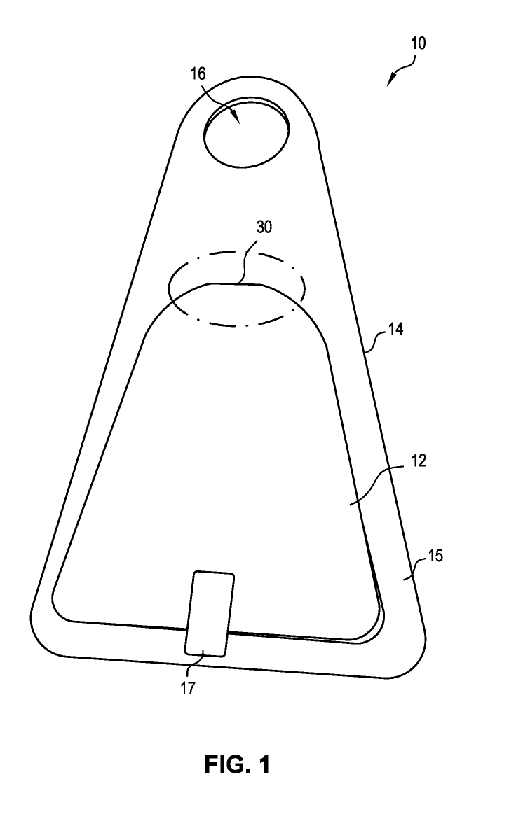

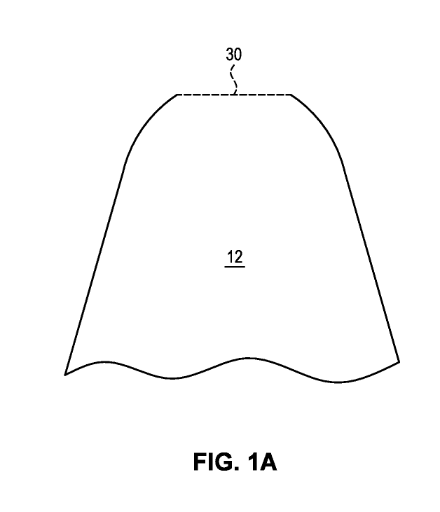

Referring now to FIG. 1, a top view of one example of a disposable pet waste collector is schematically shown. The disposable pet waste collector 10 includes a frame 14 having a top side 15 with a flap 12 removably attached to the frame 14 so that the flap 12 is displaceable between a folded position and an operative position. Here the flap 12 is shown in the folded or closed position. Also included in one example is a hole 16 cut into the frame sized to fit over a finger, for example. Note, in one example embodiment, when folded the disposable pet waste collector is sized to fit into a shirt pocket or the like for ease in carrying to the eventual site of waste collection. In one example, a tab 17 may be attached to the flap where the tab protrudes from one end.

Referring now to FIG. 1A, an expanded view of a perforated hinge attaching a flap to a frame of a disposable pet waste collector. In one useful example embodiment, the flap 12 is attached to the frame 14 by a perforated hinge 30. The perforations allow the frame to be removed for use as a scoop or shovel if desired. In one example embodiment, the perforation line forming the hinge is straight where it is connected to the frame. The rest of the flap is cleanly cut along a substantially curved border.

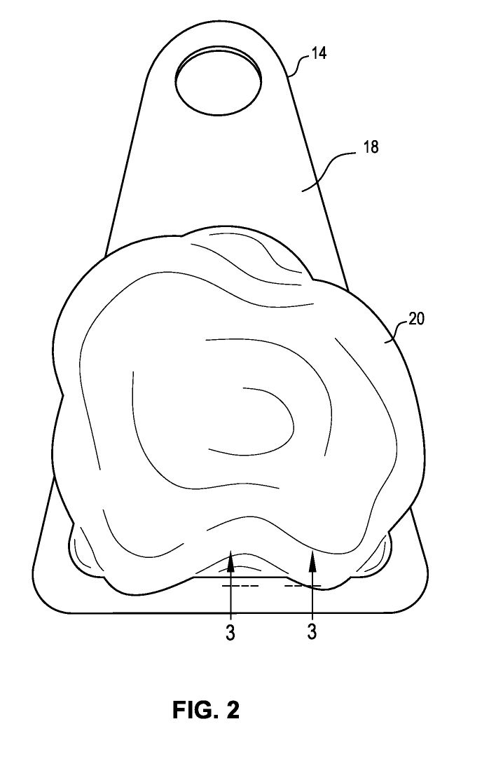

Referring now to FIG. 2, a view of the back side of a disposable pet waste collector with an opened bag is shown. The frame 14 includes a back side 18 and a bag 20 is attached to the frame. The bag 20 is sized to operate as a waste receptacle when opened into an operative position.

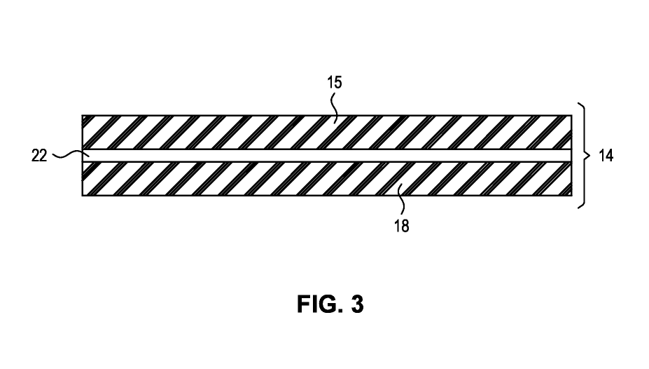

Referring now to FIG. 3, a cut-away side view of a disposable pet waste collector illustrating attachment of a bag to the frame is schematically shown. An edge 22 of the bag is juxtaposed between the top side 15 and the bottom side 18 of a portion of the frame 14. The bag edge may be affixed by gluing between the top and bottom frame sides, for example. The top and bottom sides of the frame may be affixed to each other at the same time that the bag is attached using gluing or similar known methods. Other well-known fixatives or devices may be used to form the frame and hold the bag in place.

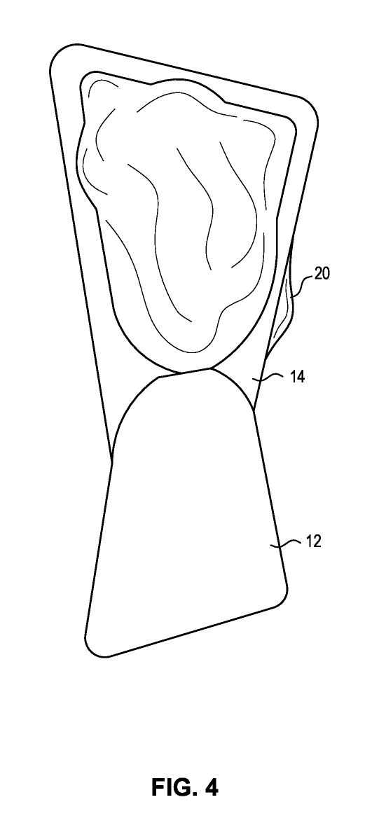

Referring now to FIG. 4, a top view of a disposable pet waste collector with a flap opened to form an extended handle is schematically shown. When opened and folded over into an operative position, the flap 12 forms a handle with the end of the frame 14, where the handle extends beyond the top of the frame 14.

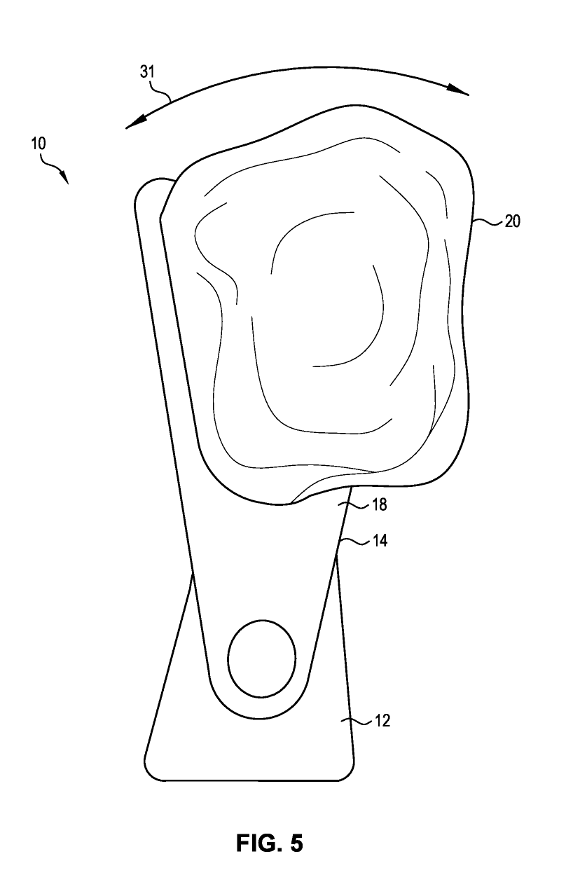

Referring now to FIG. 5 a disposable pet waste collector in an operable position is schematically shown. Here the disposable pet waste collector 10 is shown placed over pet waste or other item. In order to move the waste into the bag 20 the user uses a waggling motion as illustrated by double arrow 31. Waggling may comprise a quick side to side motion that propels the waste into the bag 20 followed by turning over the collector with the waste safely held in the bag. The flap 12 can then be closed over the bag for disposable.

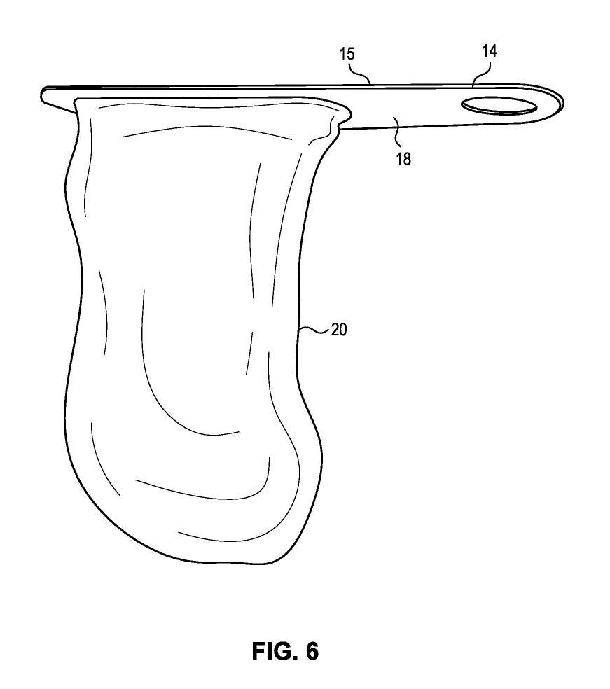

Referring now to FIG. 6, a side view a disposable pet waste collector is shown. Here the bag 20 is shown opened into a position for containing waste. The (not shown) flap 12 is closed so that any waste contained in the bag 20 can be carried to a waste disposal.

In one useful embodiment, the frame may be substantially triangular having a rounded top, although other geometric shapes may be employed. Similarly, the flap may also be substantially triangular having a rounded top portion. The frame and flap may be manufactured using various techniques, such as die cutting. The frame and flap may advantageously be made from material including a biodegradable polymer, plastic, paper, card board, chip board coated with polylactide (PLA), poly(butylene adipate-co-terephthalate) (PBAT) or other coating materials and combinations thereof. The bag may advantageously be made from a biodegradable polymer, fabric, plastic, paper, polylactide (PLA), poly(butylene adipate-co-terephthalate) (PBAT) or the like and combinations thereof. The bag may be made using various techniques. In one example, the bag is made by heat sealing two sheets of material together around three sides, leaving an opening with an edge 22 (as shown in FIG. 3).

Having described the disposable pet waste collector of the invention, methods for using the invention will now be described to promote further understanding of the invention. One useful method of collecting pet waste includes the steps of:

opening a flap coupled to a flexible frame from a folded position of the frame to an operative position thereof to expose a collection opening in the flexible frame;

opening a bag attached to the flexible frame so that the bag forms a receptacle protruding outwards from the collection opening;

positioning the frame on a surface so that the collection opening is disposed over the pet waste; and

waggling the flexible frame to collect the pet waste in the bag.
Once the waste is in the bag the frame may be turned over and the flap closed in order to allow a user to safely carry the loaded collector to a proper disposal area.

An alternate method of collecting pet waste includes the steps of:

detaching a flap coupled to a frame from a folded position of the frame to an operative position thereof to expose a collection opening in the frame;

opening a bag attached to the frame so that the bag forms a receptacle protruding away from the collection opening;

positioning the frame on a surface so that the collection opening is disposed proximate the pet waste; and

using the detached flap to collect the pet waste by moving it into the bag.

Alternatively the frame can be used as a scooper whereby the flap serves as a stopper.

The invention has been described herein in considerable detail in order to comply with the Patent Statutes and to provide those skilled in the art with the information needed to apply the novel principles of the present invention, and to construct and use such exemplary and specialized components as are required. However, it is to be understood that the invention may be carried out by specifically different equipment, and devices, and that various modifications, both as to the equipment details and operating procedures, may be accomplished without departing from the true spirit and scope of the present invention.

1. A disposable pet waste collector comprising:
a frame, wherein the frame is substantially triangular having a top;
a flap attached to the frame at a hinge, the flap being displaceable between a folded position and an operative position, wherein the flap forms a handle extension extending beyond the top of the frame when opened to the operative position; and
a bag attached to the frame and configured to collect a pet's waste in the operative position of the flap.

2. The collector of claim 1, wherein the frame is substantially triangular having a rounded top.

3. The collector of claim 1, wherein the flap is substantially triangular having a rounded edge with a straight top portion and is attached to the frame with a perforated hinge so as to allow the flap to be removed.

4. (canceled)

5. The collector of claim 1, wherein the frame comprises a front side and a back side and the bag is affixed to the frame at a top edge juxtaposed between the front side and the back side.

6. The collector of claim 1 wherein the bag comprises material selected from the group consisting of a biodegradable polymer, fabric, plastic, paper, poly(butylene adipate-co-terephthalate) (PBAT), polylactide (PLA) and combinations thereof.

7. The collector of claim 1, wherein the frame comprises material selected from the group consisting of a biodegradable polymer, plastic, paper, card board, and chip board.

8. The collector of claim 1 wherein the frame is coated with polylactide (PLA), poly(butylene adipate-co-terephthalate) (PBAT) or other coating materials and combinations thereof.

9. The collector of claim 1, wherein the bag is operable to fold into a substantially flat position against the frame.

10. The collector of claim 1, wherein the bag is operable to expand into an open receptacle when collecting waste.

11. The collector of claim 1, wherein the flap further comprises a tab protruding from one end.

12-18. (canceled)

19. The collector of claim 1, wherein the flap is removeably attached to the frame.
